(19) United States
(12) Patent Application Publication
(10) Pub. No.: US 2025/0253078 A1
(43) Pub. Date: Aug. 7, 2025

(54) RARE EARTH MAGNET AND METHOD FOR MANUFACTURING THE SAME

(71) Applicant: HONDA MOTOR CO., LTD., Tokyo (JP)

(72) Inventors: Akihito NINOMIYA, Saitama (JP); Yasutaka SHINTANI, Saitama (JP); Ibuki OTA, Saitama (JP)

(21) Appl. No.: 19/033,095

(22) Filed: Jan. 21, 2025

(30) Foreign Application Priority Data
Feb. 2, 2024 (JP) 2024-014683

(51) Int. Cl. H01F 1/053; H01F 41/02

(52) U.S. Cl. CPC H01F 1/053; H01F 41/0266

(57) ABSTRACT

Provided is a rare earth magnet and a method for manufacturing the same, which achieve both high magnetic properties and low eddy current loss. A rare earth magnet comprises coated magnet powder particles, each comprising a flake-shaped rare earth magnet powder particle and an insulating material coating provided thereon. In a plane perpendicular to a magnetization direction of the rare earth magnet, the rare earth magnet powder particles have a shorter average dimension in a first direction than an average dimension in a third direction perpendicular to the first direction. Its manufacturing method comprises a first molding operation including applying pressure to the coated magnet powder particles in the first direction to produce a first molded product, and a second molding operation including applying pressure to the first molded product in a second direction that intersects with the first direction, causing plastic deformation to produce the rare earth magnet.

### TECHNICAL FIELD

The present invention relates to a rare earth magnet and a method for manufacturing a rare earth magnet.

### BACKGROUND ART

In recent years, efforts directed toward realizing a low-carbon or a decarbonized society have become more active, and for vehicles, research and development related to electrification technology are also being conducted in order to reduce CO₂ emissions and to improve energy efficiency. Methods for improving energy efficiency include to improve the efficiency of motors used as power sources. Recently, rare earth magnets have been used more and more to improve motor efficiency. Since rare earth magnets are metallic magnets, their electrical resistance is generally low, which causes a problem that incorporating rare earth magnets into a motor increases eddy current loss, which reduces the efficiency of the motor. Various proposals have been made about how to reduce eddy current loss.

Patent Document 1 discloses a rare earth magnet capable of reducing eddy current losses, having rare earth magnet powder particles, each covered with a film-like coating layer containing rare earth oxides. Bond portions containing rare earth oxide particles are interposed between the coated rare earth magnet powder particles. A method of producing the rare earth magnet comprises conducting high temperature and pressure forming of a mixture of rare earth oxides and rare earth magnet powder particles coated with the rare earth oxides.

Patent Document 2 discloses a method of manufacturing a rare earth magnet comprising: mixing Nd-Fe-B magnet powder with an oxide such as CaO, and a nitride such as BN or a fluoride such as CaF2 for the purpose of high electrical resistance; and processing a resulting mixture by hot plastic molding, to produce an anisotropic magnet.

Patent Document 3 discloses that a first method of manufacturing a rare earth magnet comprises: preparing isotropic rapid-cooled powder particles such as Nd-Fe-B magnet powder particles; mixing the isotropic rapid-cooled powder particles with a predetermined compound for forming insulating layers; processing the mixture by cold molding to produce a cold molded product (temporary molding); and processing the cold molded product by hot molding (densifying); and processing, by hot plastic molding, the resultant product (imparting anisotropy) to produce the rare earth magnet, and that a so-produced magnet includes generally stacked Nd-Fe-B rapid-cooled powder particles with the compound powder material therebetween, each particle having a long side length of 100 to 400 μm and a thickness of 20 to 40 μm.

### PRIOR ART DOCUMENT(S)

### Patent Document(s)

Patent Document 1: JP4784173B

Patent Document 2: JP2003-022905A

Patent Document 3: JP2010-027852A

### SUMMARY OF THE INVENTION

### Task to be Accomplished by the Invention

In order to minimize the deterioration of magnetic properties of a rare earth magnet, it is desirable to reduce the amount of an insulating compound material to be mixed with magnet powder particles. However, since each of the magnet powder particles is flake-shaped, the magnet powder particles are generally stacked in the step of densifying the mixture of magnet powder particles and the insulating compound material. Thus, when performing the method of manufacturing a magnet of the prior art, the process of hot plastic molding (densifying) causes the magnet powder particles and the insulating compound material to deform and spread in directions perpendicular to a pressing direction (i.e., along main surfaces of the magnet powder particles). This means that a decreased amount of insulating compound material is likely to cause breaks in insulating layers during the process of hot plastic molding, thereby forming electrical connections between magnet powder particles, which should have been separated by the insulating layers. In such a case, a larger eddy current path (less effective in breaking up the eddy current path) is formed in the produced magnet, resulting in occurrence of a larger eddy current loss during operation of a motor using the magnet.

The present invention has been made in view of the above-described problem of the prior art, and a primary object of the present invention is to provide a rare earth magnet and a method for manufacturing the same, which achieve both high magnetic properties and low eddy current loss.

### Means to Accomplish the Task

As a solution to the above-described tasks to be accomplished, an aspect of the present invention provides a rare earth magnet (1) comprising coated magnet powder particles (5), each of which comprises a flake-shaped rare earth magnet powder particle (2) and a coating (4) of an insulating material on a surface thereof, wherein the rare earth magnet has a magnetization direction, and wherein, in a transverse plane perpendicular to the magnetization direction, the rare earth magnet powder particles have a shorter average dimension in a first direction than an average dimension in a third direction which is perpendicular to the first direction.

The rare earth magnet is produced by plastically molding a material by applying pressure in the magnetization direction; that is, the material is pressed in a pressing direction which is not perpendicular to main surfaces of the rare earth magnet powder particles prior to the pressing. This configuration prevents the coatings of the insulating compound material from significantly spreading along the main surfaces of the rare earth magnet powder particles during the plastic deforming process, which prevents occurrence of breaks in the coatings. This suppresses an increase in eddy current loss. In other words, this configuration allows for a decrease in the amount of insulating compound material while preventing the occurrence of breaks in the coatings, which minimizes the deterioration of magnetic properties of the rare earth magnet.

Preferably, the above rare earth magnet may be further configured such that, in a cross section of the rare earth magnet extending in the magnetization direction at a cutting angle which is defined in the transverse plane, the average dimension of the rare earth magnet powder particles in a direction perpendicular to the magnetization direction, varies with the cutting angle of the cross section such that the average dimension has two peaks at cutting angles within a range from 0 to 360 degrees.

In cross sections extending between the two cross sections extending in the first and third directions, the average dimensions of the rare earth magnet powder particles are approximately the same. Thus, in this configuration, multiple (e.g., four) cross sections in planes extending at different cutting angles defined in the transverse plane, make it possible to confirm that rare earth magnet powder particles are present side by side in a plane perpendicular to the magnetization direction such that the respective longitudinal directions of the rare earth magnet powder particles are aligned with each other.

Preferably, the above rare earth magnet may be further configured such that the insulating material is an alkali metal fluoride or an alkaline earth metal fluoride.

This configuration minimizes the reaction between the coating, which is formed of the alkali metal fluorides or alkaline earth metal fluoride, and the rear earth in the material of the rare earth magnet powder particles. This prevents the deterioration of magnetic properties of the rare earth magnet powder particles and that of insulating properties of the coating.

As a solution to the above-described tasks to be accomplished, another aspect of the present invention provides a method for manufacturing a rare earth magnet (1) comprising: adding an insulating material to magnetic powder particles to produce coated magnet powder particles (5), such that each of the coated magnet powder particles comprises a flake-shaped rare earth magnet powder particle and a coating of the insulating material on a surface thereof (FIG. 1(B)); performing a first molding operation which includes placing the coated magnet powder particles in a mold (10) configured to allow for pressurization in a first direction, and applying pressure to the coated magnet powder particles in the mold in the first direction, thereby compressively deforming the coated magnet powder particles to produce a first molded product (6) (FIG. 1(C)); and performing a second molding operation which includes applying pressure to the first molded product in second direction that intersects with the first direction, thereby plastically deforming the first molded product to produce the rare earth magnet (FIG. 1(E)).

In the second molding operation of this configuration, when being compressed in the second direction, the coated magnet powder particles of the first molded product spread in the third direction which is perpendicular to the first and second directions. This prevents the thicknesses of the coatings on the main surfaces of the rare earth magnet powder particles (i.e., the thicknesses in the first direction) from easily becoming thinner. This further prevents the occurrence of breaks in the coatings, which suppresses an increase in eddy current loss. Thus, this configuration allows for a decrease in the amount of insulating compound material, thereby minimizing the deterioration of magnetic properties of the rare earth magnet caused by the addition of the insulating compound material.

Preferably, the above method may be further configured such that the second direction is perpendicular to the first direction.

This configuration effectively prevents the coatings from becoming thinner in the first direction, which effectively suppresses an increase in eddy current loss. Thus, this configuration allows for a further decrease in the amount of insulating compound material.

Preferably, the above method may be further configured such that the first molding operation includes pressing the coated magnet powder particles while restricting deformation of the coated magnet powder particles in a direction that is perpendicular to the first direction, and wherein the second molding operation includes pressing the first molded product without restricting deformation of the first molded product in a direction that is perpendicular to the second direction.

In this configuration, the first molding operation allows for the increases in the density and strength of the first molded product, and the second molding operation allows the coated magnet powder particles to spread in the third direction, which enables the crystal orientation to be made anisotropic.

Preferably, the above method may be further configured such that the second molding operation is performed by using a process of hot plastic molding, which causes plastic deformation of the first molded product at high temperatures.

In this configuration, the crystal grains rotate to allow the respective magnetization easy axes to be directed to the second direction, the second direction being the pressing direction; that is, to be aligned with each other, which allows the crystal orientation to be effectively made anisotropic. In addition, this configuration allows the organization of the rare earth magnet to become dense, reducing internal defects, which improves the strength and hardness of the rare earth magnet.

Preferably, the above method may be further configured such that the second molding operation is performed at a higher temperature than a temperature at which the first molding operation is performed.

In this configuration, liquid phases are more likely to form at grain boundaries, which allows the crystal orientation to be effectively made anisotropic. This configuration also allows the rare earth magnet powder particles to be plastically deformed with a high compaction rate (fractional reduction in upsetting height).

### Effect of the Invention

As described above, the present invention can be embodied as a rare earth magnet and a method for manufacturing the same, which achieve both high magnetic properties and low eddy current loss.

### BRIEF DESCRIPTION OF THE DRAWINGS

FIG. 1 is an explanatory diagram showing a method for manufacturing a rare earth magnet according to an embodiment of the present invention, and includes FIGS. 1(A) to 1(E);

FIG. 2 shows an SEM image of a cross-section of a first molded product of the rare earth magnet after the first molding operation;

FIGS. 3A and 3B show images of cross-sections taken along the magnetization direction of the rare earth magnet after the second molding operation, where FIG. 3A shows an SEM image of a cross section taken along a first direction, and FIG. 3B shows an SEM image of a cross section taken along a third direction.

FIG. 4 is a plan view of the rare earth magnet viewed from the magnetization direction;

FIG. 5 is a graphic representation showing shape characteristics of the rare earth magnet powder particles in the rare earth magnet;

FIG. 6 is an explanatory diagram showing a method for manufacturing a rare earth magnet according to a comparative example, and includes FIGS. 6(A) and 6(B); and

FIG. 7 is an SEM image of a cross section of the rare earth magnet after the second molding operation, according to the comparative example.

### DESCRIPTION OF THE PREFERRED EMBODIMENT(S)

Embodiments of the present invention will be described below, with reference to the appended drawings.

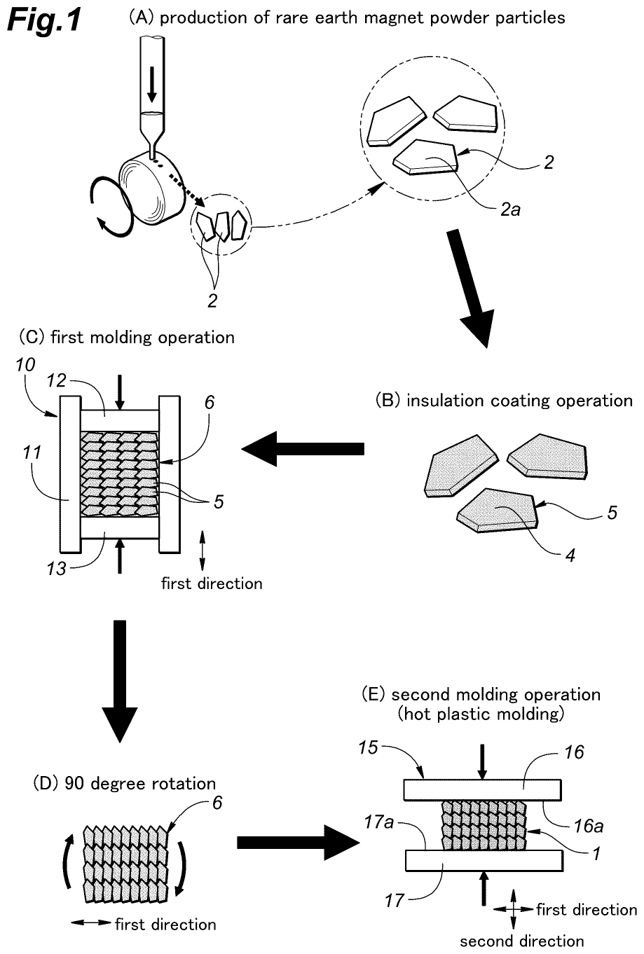

First, a manufacturing method of a rare earth magnet 1 of an embodiment of the present invention will be described below. FIG. 1 is an explanatory diagram showing a method for manufacturing a rare earth magnet of the embodiment of the present invention. As shown in FIG. 1(A), the first process is a step of producing rare earth magnet powder particles 2. This process produces rare earth magnet powder particles 2 to be used.

Examples of materials of the rare earth magnet powder particles 2 include, but not limited to, a neodymium magnet (Nd-Fe-B magnet, or more precisely Nd₂Fe₁₄B). An example of a method of manufacturing rare earth magnet powder particles 2 from a raw material of rare earth magnets is the melt spinning method. The melt spinning method includes spraying a high-temperature molten alloy onto a cooled roll for rapid cooling, thereby producing fine magnetic powder particles for magnets in the form of flakes (thin flakes) containing Nd-Fe-B crystals.

The rare earth magnet powder particles 2 produced in the process are isotropic rapid-cooled powder particles with non-aligned crystal directions, and each of the particles is flake-shaped, and thus has main surfaces 2a. The term “main surface 2a” is defined herein as each pair of the largest opposing flat surfaces. Each of the rare earth magnet powder particles 2 has an aspect ratio of approximately 1 (e.g., 0.7 to 1.0) when viewed from a direction perpendicular to the main surfaces 2a. The term “aspect ratio” refers to a ratio of the short diameter (minor axis diameter) to the long diameter (major axis diameter) of an object, and is expressed as b/a, where “a” is a long diameter and “b” is a short diameter. The term “major axis (major axis diameter)” refers to the maximum Feret diameter, and the term “minor axis (minor axis diameter)” refers to the minimum Feret diameter. The method for measuring the major and minor axes is compliant with the provisions of JIS Z 8890:2017 “Particle characterization of particulate systems.”

Next, as shown in FIG. 1(B), an insulation coating operation is performed to form an insulation coating on the surfaces of rare earth magnet powder particles 2. This operation involves adding an insulating material to rare earth magnet powder particles 2 so that a coating 4 is formed on a surface of each rare earth magnet powder particle 2, to thereby produce coated magnet powder particles 5 with the coatings 4 formed thereon.

Examples of preferable insulating materials include, but not limited to, alkali metal fluorides or alkaline earth metal fluorides. In the present embodiment, calcium fluoride (CaF₂), which is an alkaline earth metal fluoride, is used as the insulating material, but the insulating material is not limited to calcium fluoride. In some cases, the insulating material may be an alkaline earth metal fluoride (e.g., magnesium fluoride, barium fluoride, or strontium fluoride), an alkaline metal fluoride (e.g., lithium fluoride), or a combination (i.e., mixture) thereof.

Examples of methods for forming a coating 4 on the surface of each of the rare earth magnet powder particles 2 include, but not limited to, sputtering. Another example of a method for forming a coating may be a method including spraying a fluid dispersion of alkali metal fluoride particles or alkaline earth metal fluoride particles onto the rare earth magnet powder particles 2, and then drying the coated rare earth magnet powder particles 2 to thereby form an alkali metal fluoride or alkaline earth metal fluoride coating 4 on the surface of each of the rare earth magnet powder particles 2.

Then, as shown in FIG. 1(C), a first molding operation for forming (molding) coated magnet powder particles 5 is performed. This operation includes placing the coated magnet powder particles 5 in the first mold 10 (hot press machine), and applying pressure to the coated magnet powder particles 5 with the first mold 10 in a first direction, thereby compressively deforming the coated magnet powder particles 5 to produce a first molded product 6 of the rare earth magnet 1 in which the coated magnet powder particles 5 have been densified.

The first mold 10 includes a cylindrical mold body 11 with a cross-sectional shape conforming to the shape of the first molded product 6, and an upper mold 12 and a lower mold 13 capable of applying a compressive force in the first direction to an object in the mold body 11. Thus, the first molding operation includes applying pressure to the coated magnet powder particles 5 while restricting deformation of the coated magnet powder particles 5 in a direction perpendicular to the first direction, thereby forming the first molded product 6. In the present embodiment, the first direction is a vertical direction, but is not limited thereto.

The first molding operation includes processing, by hot press molding, the coated magnet powder particles 5 into the first molded product 6, in which the first mold 10 is heated to a predetermined temperature and a predetermined pressure is applied for a predetermined time. When being compressively deformed by the pressure, the coated magnet powder particles 5 in the first mold 10 are oriented such that the main surfaces 2a of each of the rare earth magnet powder particles 2 face the first direction, resulting in that the coated magnet powder particles 5 are stacked on each other in the direction perpendicular to the main surface 2a (i.e., the first direction).

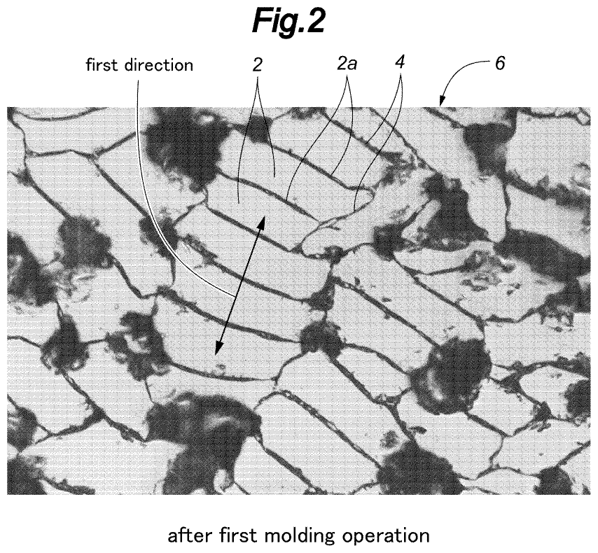

FIG. 2 shows an SEM image of a cross-section of the first molded product 6 of the rare earth magnet 1 after the first molding operation. As shown in FIG. 2, the first molded product 6 of the rare earth magnet 1 contains the rare earth magnet powder particles 2 that are stacked in a direction perpendicular to the main surface 2a (i.e., the first direction).

The first molding operation for forming the first molded product 6 is performed by using a process of hot compression, in which the coated magnet powder particles 5 are compressed and deformed at high temperatures, and the first mold 10 is heated to a predetermined temperature. The predetermined temperature is preferably a temperature within a range from about 600° C. to about 700° C., preferably 640° C.

After the first molding operation, a rotation operation is performed in which the resulting first molded product 6 is removed from the first mold 10 and rotated 90 degrees, as shown in FIG. 1(D). The rotation of the first molded product 6 is performed around an axis of rotation in the horizontal plane, i.e., around an axis parallel to the main surfaces 2a of each of the rare earth magnet powder particles 2. In the present embodiment, the angle of rotation of the first molded product 6 is 90 degrees. Although the angle is not limited to 90 degrees, the angle of rotation is preferably close to 90 degrees, and more preferably 90 degrees, which is perpendicular to the first direction.

Then, as shown in FIG. 1(E), a second molding operation for molding the first molded product 6 is performed. This operation includes, after rotating the first molded product 6 to the angle as shown in FIG. 1(D), placing the first molded product 6 in a second mold 15, and applying pressure to the first molded product with the second mold 15 in a second direction, the second direction intersecting the first direction, which is the pressing direction in the first molding operation (i.e., the direction of stacking of the rare earth magnet powder particles 2), thereby plastically deforming the first molded product 6 to produce the rare earth magnet 1 (that is a second molded product).

The rotation operation shown in FIG. 1(D) is required since the pressing direction of the second molding operation shown in FIG. 1(E) is the same vertical direction as that of the first molding operation. Thus, in some cases, the rotation operation shown in FIG. 1(D) is not required when the pressing direction of the second molding operation is different from that of the first molding operation, e.g., when the pressing direction of the second molding operation is a horizontal direction.

The second mold 15 includes an upper mold 16 and a lower mold 17, which are opposite to each other. The upper mold 16 and lower mold 17 have an upper pressure surface 16a and a lower pressure surface 17a which conform to the shape of the first molded product 6 and are capable of applying pressure to the first molded product 6 in the second direction (vertical in the present embodiment). Since, in the present embodiment, the first molded product 6 has a rectangular shape, the upper mold 16 and the lower mold 17 have an upper pressure surface 16a and a lower pressure surface 17a, which are a pair of horizontal surfaces facing and parallel to each other, and configured to apply a compression force to the first molded product 6 in a vertical direction, which is perpendicular to the first direction.

The second molding operation includes pressing the first molded product 6 without restricting deformation of the first molded product 6 in the direction perpendicular to the second direction. Thus, in the second molding operation, the first molded product 6 is plastically deformed by compressing the first molded product 6 in the vertical direction, which is the pressing direction of the second molding operation, while allowing the first molded product 6 to deform in the horizontal direction perpendicular to the vertical direction. Specifically, for each of the rare earth magnet powder particles 2 in the rare earth magnet 1, the thickness (dimension in the first direction) becomes thicker than when being present in the first molded product 6 before the second molding operation. The aspect ratio of each of the rare earth magnet powder particle 2 in the rare earth magnet 1 viewed from the first direction becomes smaller than when being present in the first molded product 6 before the second molding operation. The aspect ratio of each of the rare earth magnet powder particles 2 in the rare earth magnet 1 is preferably smaller than 1, e.g., 0.15 to 0.5.

In the process of hot plastic molding, the rare earth magnet powder particles 2 of the first molded product 6 develop magnetic anisotropy (uniaxial anisotropy) with the c-axis directions (magnetization easy direction) of the crystal grains oriented parallel to the pressing direction. The rare earth magnet powder particles 2 of the rare earth magnet 1 are magnetized in the direction of this magnetic anisotropy.

In this way, in the second molding operation, the first molded product 6 is pressed in the second direction, which intersects the first direction, and plastically deformed. This causes the rare earth magnet powder particles 2 and the coating 4 around the particles to spread in the direction perpendicular to the second direction, i.e., the first direction and a third direction. In other words, the coating 4 between the rare earth magnet powder particles 2 adjacent to each other in the first direction becomes thinner by spreading in the third direction, while not spreading in the second direction. This prevents the coating 4 from becoming too thin in the first direction, which reduces an increase in eddy current loss. Details of this effect will be discussed later.

The second molding operation is performed by using a process of hot compression, in which the second mold 15 is heated to a predetermined temperature to compress and deform the first molded product 6, more specifically, by using a process of hot plastic molding, in which the first molded product 6 is plastically deformed at a higher temperature than the first molding operation. The temperature of the second mold 15 in the second molding operation is preferably a temperature at which some of the crystal grains of the rare earth magnet powder particles 2 undergo a phase change to the liquid phase, e.g., about 850 degrees. The process allows the rare earth magnet powder particles 2 to be plastically deformed with a high compaction rate. In the present embodiment, the first molded product 6 of the rare earth magnet 1 is plastically processed with a compaction rate of about 70% in the second molding operation.

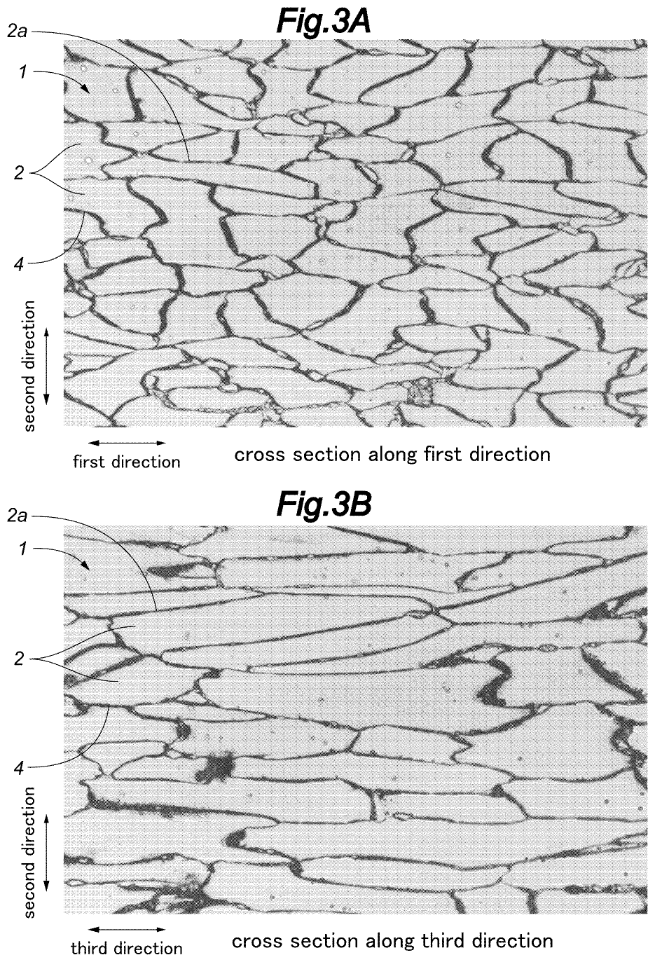

FIGS. 3A and 3B show images of cross-sections taken along the magnetization direction of the rare earth magnet 1 after the second molding operation. FIG. 3A shows an SEM image of a cross section taken along the first direction, and FIG. 3B shows an SEM image of a cross section taken along the third direction. The third direction is a direction perpendicular to the first and second directions. Each of the rare earth magnet powder particles 2 in the rare earth magnet 1 generally has short and long diameters in the first and third directions as shown in FIG. 3A and FIG. 3B, respectively. In the present embodiment, the aspect ratio of each of the rare earth magnet powder particles 2 is about 0.2. As shown in FIG. 3A, an average value of short diameters of the rare earth magnet powder particles 2 is approximately the same as that of dimensions in the first direction (dimensions in the thickness direction) of the rare earth magnet powder particle 2.

As the coated magnet powder particles 5 are plastically deformed into this shape and spread in the third direction, the coating 4 spreads in the third direction and is compressed in the second direction. In other words, the coating 4 of an insulating material is prevented from spreading significantly along the main surface 2a of the rare earth magnet powder particles 2 during the process of plastic molding, which prevents the occurrence of breaks in the coatings. This suppresses an increase in eddy current loss. In other words, the above-described process allows for a decrease in the amount of insulating material while preventing the occurrence of breaks in the coatings 4, which minimizes the deterioration of magnetic properties of the rare earth magnet.

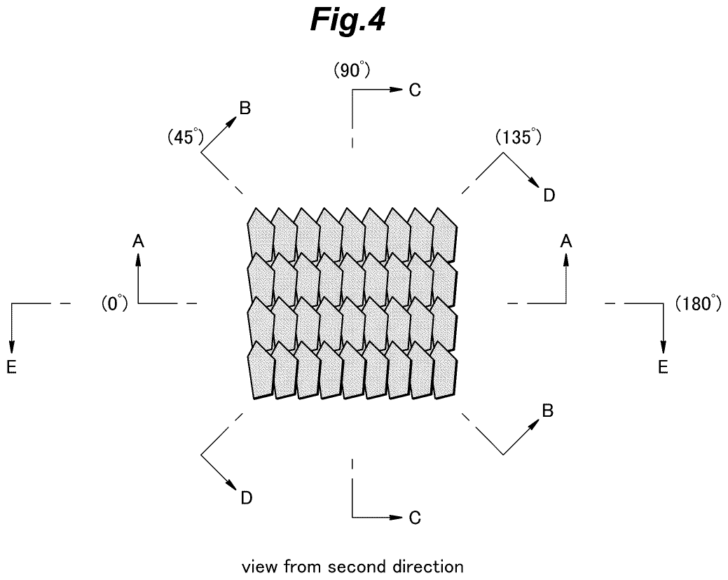

The particle shapes of rare earth magnet powder particles 2 in a plane perpendicular to the magnetization direction of the rare earth magnet 1 will be described in detail. FIG. 4 is an explanatory diagram showing the particle shape of rare earth magnet powder particle 2, and also a plan view of the rare earth magnet 1 viewed from the magnetization direction. In the second molding operation, pressure is applied to the rare earth magnet powder particles 2 in the second direction, which intersects the first direction, resulting in that the rare earth magnet powder particles 2 are present side by side in a plane perpendicular to the magnetization direction (in which the plan view of FIG. 4 is viewed) such that the respective longitudinal directions of the rare earth magnet powder particles are aligned with each other. However, it is difficult to identify the first and third directions directly from the outside of the rare earth magnet 1. Thus, performing operations of cutting the rare earth magnet 1 along cutting lines at various angles defined as viewed from the magnetization direction as shown in FIG. 4, and determining, in each of the cross sections, an average dimension of the rare earth magnet powder particles 2 in a direction, which is perpendicular to the magnetization direction, to thereby enable the identification of shape characteristics of the rare earth magnet powder particles in the rare earth magnet

In an example shown in FIG. 4, all cutting lines are determined to pass through a single point on the rare earth magnet 1. However, in other cases, cutting lines may be determined at positions that are far apart from each other. In the example shown, the cutting lines are at 45 degrees intervals. The A-A cutting line and the E-E cutting line are essentially the same in terms of the dimensions and shape of the rare earth magnet powder particles 2, with the only difference being the direction to be viewed (shapes are symmetrical in the left-right direction).

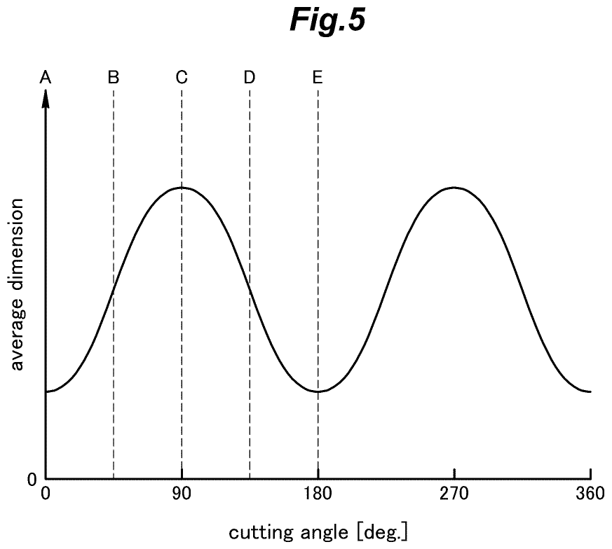

FIG. 5 is a graphic representation showing shape characteristics of the rare earth magnet powder particles 2 in the rare earth magnet 1, which indicates the correlation between the cutting angle and the average dimensions of rare earth magnet powder particles 2. The horizontal axis shows the cutting angle, and the vertical axis shows the average dimension of the rare earth magnet powder particles 2 in a direction perpendicular to the magnetization direction. A value of the average dimension corresponds to that of the average aspect ratio of the rare earth magnet powder particles 2.

Since the rare earth magnet powder particles 2 are oriented with the long axes thereof being aligned with each other in the third direction, as shown in FIG. 5, the average dimension of the rare earth magnet powder particles 2 in the direction perpendicular to the magnetization direction, has two peaks at cutting angles within a range of 0 to 360 degrees defined in a transverse plane, i.e., a plane perpendicular to the magnetization direction. In this example, the C-C cross-section in FIG. 4 is in a plane parallel to the long axes of the rare earth magnet powder particles 2, i.e. along the third direction. The A-A cross-section is in a plane parallel to the short axes of the rare earth magnet powder particle 2, i.e. along the first direction.

In the B-B and D-D cross-sections extending between the two cross sections extending in the first and third directions, the average dimensions of the rare earth magnet powder particles 2 are approximately the same. Thus, in this example, use of four cross sections extending at different cutting angles defined in a transverse plane (i.e., a plane perpendicular to the magnetization direction) makes it possible to confirm that rare earth magnet powder particles 2 are present side by side in the transverse plane such that the respective longitudinal directions of the rare earth magnet powder particles 2 are aligned with each other.

Next, a method for manufacturing the rare earth magnet 101 of a comparative example will be described first, and then effects achieved by the rare earth magnet 101 and the method for manufacturing the same according to the embodiments of the present invention will be described.

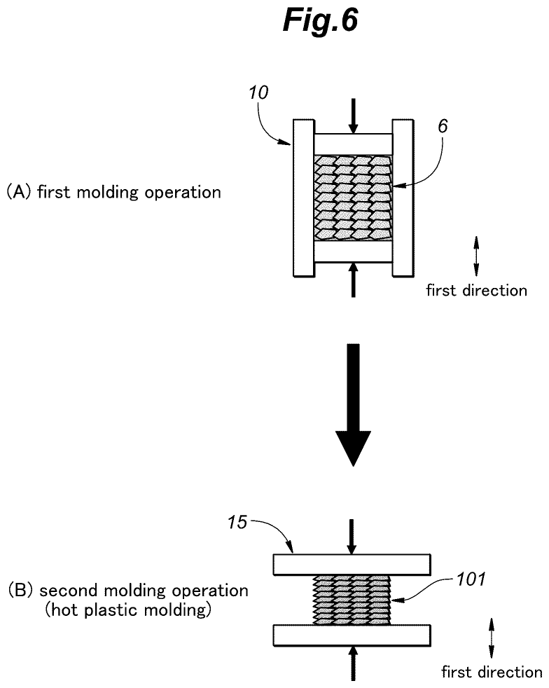

FIG. 6 is an explanatory diagram showing a method for manufacturing a rare earth magnet 101 according to a comparative example, showing processing operations corresponding to those shown in FIGS. 1(A) and 1(B). As shown in FIG. 6(A), the first molding operation is also performed on the coated magnet powder particles 5 in the comparative example. In this process, the same operation as the present invention described with reference to FIG. 1(C) is performed.

Subsequently, as shown in FIG. 6(B), a second molding operation is performed on the first molded product 6 transferred from the first mold 10. In this process, the first molded product 6 is placed in the second mold 15 such that the second direction, which is a pressing direction, is the same as the first direction, which is the pressing direction for the first mold 10. Then, the second molding operation involves pressing the first molded product 6 in the same direction as the pressing direction of the first molding operation, thereby plastically deforming the first molded product 6 to produce the rare earth magnet 101.

The comparative example is the same as the above embodiments of the present invention in that the second molding operation is performed by using a process of hot plastic molding, in which the first molded product 6 is plastically deformed at high temperature using the second mold 15. The comparative example is different from the present invention in that the pressing direction of the first molded product 6 for the second mold 15 differs from the above embodiments of the present invention.

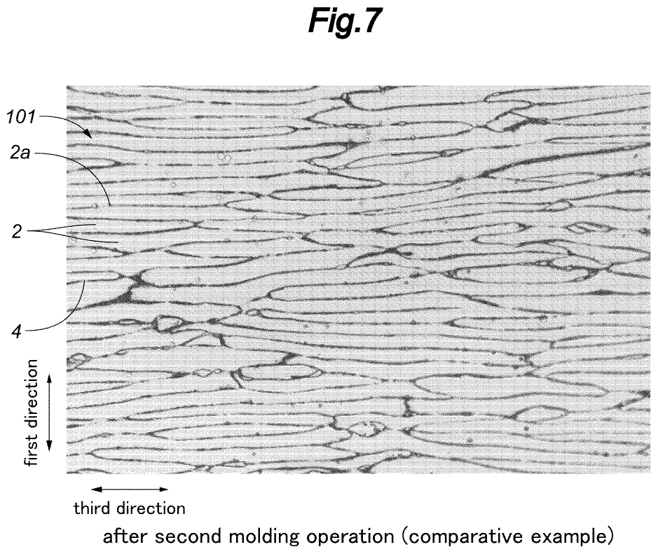

FIG. 7 is an SEM image of a cross section of the rare earth magnet 101 after the second molding operation, according to the comparative example. As shown in FIG. 7, the rare earth magnet 101 produced by this manufacturing method, has been plastically deformed, so that rare earth magnet powder particles 2 are thinner in the first direction than those after the first molding operation as shown in FIG. 2, and spread in directions perpendicular to the first direction (second and third directions). FIG. 7 shows only a cross-section in the third direction, in which each of the rare earth magnet powder particles 2 is disk-shaped, and the same shapes are also seen in a cross-section in the second direction, perpendicular to the third direction in FIG. 7. The aspect ratio of each of the rare earth magnet powder particles 2 in the rare earth magnet 101 is the same as the aspect ratio of each rare earth magnet powder particle 2 in the first molded product 6, which is 0.7 to 1.0.

In the comparative example, the rare earth magnet powder particles 2 deform and spread in directions perpendicular to the first direction in both the first molding operation and the second molding operation. In other words, in both of the molding operations, the coating 4, which is made of an insulating material, spreads in the second and third directions along the main surface 2a between rare earth magnet powder particles 2 adjacent to each other in the first direction. Thus, breaks are likely to occur in the coating 4 between the rare earth magnet powder particles 2, causing adjoining rare earth magnet powder particles 2, which should have been separated by the coating 4, to be electrically connected to each other at the point of a break in the coating 4. This means that the substantial volume of each of the rare earth magnet powder particles 2 increases, resulting in occurrence of a larger eddy current loss during operation of a motor using the magnet.

In contrast, as shown in FIGS. 3A and 3B, the rare earth magnet 1 of the embodiment of the present invention is configured such that the coated magnet powder particles 5 in a plane perpendicular to the second direction, which is the magnetization direction of the rare earth magnet 1, have a short average dimension in the first direction and a long average dimension in the third direction. In other words, the pressing direction of a process of plastic molding in the second molding operation is not perpendicular to the main surface 2a of the rare earth magnet powder particles 2 before the application of pressure. As a result, as described above, the coating 4, which is made of an insulating material, is prevented from significantly spreading along the main surfaces 2a of the rare earth magnet powder particles 2 during the process of plastic molding, which prevents the occurrence of breaks in the coating 4.

As described above, the insulating material is an alkaline earth metal fluoride. This feature suppresses the reaction of the alkaline metal fluoride with the rare earth, which are materials of the coatings 4 and the rare earth magnet powder particles 2, respectively. This feature prevents the deterioration of magnetic properties of the rare earth magnet powder particles 2 and that of insulating properties of the coating 4. The same effect can be achieved when an alkaline metal fluoride is used as the insulating material.

In the method for manufacturing a rare earth magnet 1, as shown in FIGS. 1(D) and 1(E), the second molding operation involves applying pressure in the second direction that intersects the first direction, thereby plastically deforming the first molded product 6 to produce the rare earth magnet. In the second molding operation shown in FIG. 1(E), when being compressed in the second direction, the coated magnet powder particles 5 of the first molded product 6 spread in the third direction, which prevents the thicknesses of the coatings 4 along the main surface 2a of the rare earth magnet powder particles 2 (i.e., the thickness in the first direction) from easily becoming thinner. This further prevents the occurrence of breaks in the coatings 4, which suppresses an increase in eddy current loss. Thus, this configuration allows for a decrease in the amount of insulating material, thereby minimizing the deterioration of magnetic properties of the rare earth magnet 1 caused due to the addition of the insulating material.

The second direction is perpendicular to the first direction. This feature effectively prevents the coatings from becoming thinner in the first direction, which effectively suppresses an increase in eddy current loss. Thus, this feature allows for a further decrease in the amount of insulating compound material.

In some cases, the first molding operation shown in FIG. 1(C) includes pressing the coated magnet powder particles 5 with restriction on deformation of the coated magnet powder particles 5 in a direction that is perpendicular to the first direction, whereas the second molding operation includes pressing the first molded product 6 without restricting deformation of the first molded product 6 in a direction that is perpendicular to the second direction. As a result, the first molding operation allows for the increases in the density and strength of the first molded product 6, and the second molding operation allows the coated magnet powder particles 5 to spread in the third direction, which enables the crystal orientation to be made anisotropic.

In some cases, the second molding operation shown in FIG. 1(E) is performed by using a process of hot plastic molding, which causes plastic deformation of the first molded product 6 at high temperatures. As a result, the crystal grains rotate to allow the respective magnetization easy axes to be directed to the second direction, the second direction being the pressing direction; that is, to be aligned with each other, which allows the crystal orientation to be effectively made anisotropic. In addition, this feature allows the organization of the rare earth magnet 1 to become dense, reducing internal defects, which improves the strength and hardness of the rare earth magnet 1.

In some cases, the second molding operation is performed at a higher temperature than a temperature at which the first molding operation is performed. As a result, liquid phases are more likely to form at grain boundaries, which allows the crystal orientation to be effectively made anisotropic. This feature also allows the rare earth magnet powder particles 2 to be plastically deformed with a high compaction rate.

Some embodiments of the present invention have been described. However, the present invention is not limited to those specific embodiments, and may be embodied with various modifications. For example, in the above embodiments, since the rare earth magnet 1 has a rectangular prismatic shape, the first molded product 6 is rotated by 90 degrees as shown in FIG. 1(D). However, as described earlier, the rotation angle is not limited to this angle. For example, when the first molded product 6 exhibits an octagon shape as viewed horizontally, the rotation angle may be 90 or 45 degrees. When the first molded product 6 exhibits a 16-sided polygon shape as viewed horizontally, the rotation angle may be any of 22.5, 45, 67.5 or 90 degrees. When the first molded product 6 exhibits a circular shape as viewed horizontally, the rotation angle may be any angle between 0 degree to 180 degrees. Generally, various changes and modifications may be made to features of the embodiments such as specific configuration, location, quantity, and material of each component or element in the embodiments without departing from the scope of the present invention. In the above-described embodiments, not all elements included therein are essential. Thus, various modifications including elimination of some elements may be made to the embodiments as appropriate.

### GLOSSARY

1 rare earth magnet
2 rare earth magnet powder particle
4 coated
5 magnet powder particle
6 first molded product
10 first mold
15 sccond mold

1. A rare earth magnet comprising coated magnet powder particles, each of which comprises a flake-shaped rare earth magnet powder particle and a coating of an insulating material on a surface thereof,
wherein the rare earth magnet has a magnetization direction, and
wherein, in a transverse plane perpendicular to the magnetization direction, the rare earth magnet powder particles have a shorter average dimension in a first direction than an average dimension in a third direction which is perpendicular to the first direction.

2. The rare earth magnet as claimed in claim 1, wherein, in a cross section of the rare earth magnet extending in the magnetization direction at a cutting angle which is defined in the transverse plane, the average dimension of the rare earth magnet powder particles in a direction perpendicular to the magnetization direction, varies with the cutting angle of the cross section such that the average dimension has two peaks at cutting angles within a range from 0 to 360 degrees.

3. The rare earth magnet as claimed in claim 1, wherein the insulating material is an alkali metal fluoride or an alkaline earth metal fluoride.

4. A method for manufacturing a rare earth magnet comprising:
adding an insulating material to magnetic powder particles to produce coated magnet powder particles, such that each of the coated magnet powder particles comprises a flake-shaped rare earth magnet powder particle and a coating of the insulating material on a surface thereof;
performing a first molding operation which includes placing the coated magnet powder particles in a mold configured to allow for pressurization in a first direction, and applying pressure to the coated magnet powder particles in the mold in the first direction, thereby compressively deforming the coated magnet powder particles to produce a first molded product; and
performing a second molding operation which includes applying pressure to the first molded product in second direction that intersects with the first direction, thereby plastically deforming the first molded product to produce the rare earth magnet.

5. The method as claimed in claim 4, wherein the second direction is perpendicular to the first direction.

6. The method as claimed in claim 5, wherein the first molding operation includes pressing the coated magnet powder particles while restricting deformation of the coated magnet powder particles in a direction that is perpendicular to the first direction, and wherein the second molding operation includes pressing the first molded product without restricting deformation of the first molded product in a direction that is perpendicular to the second direction.

7. The method as claimed in claim 4, wherein the second molding operation is performed by using a process of hot plastic molding, which causes plastic deformation of the first molded product at high temperatures.

8. The method as claimed in claim 4, wherein the second molding operation is performed at a higher temperature than a temperature at which the first molding operation is performed.
